(19) United States
(12) Patent Application Publication
(10) Pub. No.: US 2013/0153621 A1
(43) Pub. Date: Jun. 20, 2013

(54) FASTENER DRIVING DEVICE

(71) Applicant: Hilti Aktiengesellschaft, Schaan (LI)

(72) Inventor: Karl FRANZ, Feldkirch (AT)

(73) Assignee: Hilti Aktiengesellschaft, Schaan (LI)

(21) Appl. No.: 13/713,399

(22) Filed: Dec. 13, 2012

(30) Foreign Application Priority Data
Dec. 16, 2011 (DE) 10 2011088778.4

(51) Int. Cl. B25C 1/00

(52) U.S. Cl. CPC B25C 1/00
USPC 227/146

(57) ABSTRACT

According to one aspect of the application, a device for driving a fastening element into an underlying surface comprises a force deflector. The force deflector preferably comprises a protective layer.

### TECHNICAL FIELD

The application relates to a device for deflecting forces and to a device with a force deflection device for driving fastening elements.

### PRIOR ART

Such force deflection devices are usually constructed as belts, cables or chains that run in a non-constant direction in order to deflect forces and are moved along their extension direction. Both internal and external friction occurs in this process, so the force deflection devices are subject to wear.

Fastener driving devices typically comprise a piston for transmitting energy to the fastening element. The required energy must be provided in a very short time, which is why in so-called spring nailers, for example, a spring is first tensioned that abruptly transmits the tensioning energy during the driving process to the piston and accelerates the latter toward the fastening element.

Fastener driving devices are known that are furnished with force deflection devices that are run over deflection pulleys, for example, in order to transfer forces to the piston. It is desirable in this case that the service life of the respective force deflection device at least equals the service life of the fastener driving device.

### PRESENTATION OF THE INVENTION

According to one aspect of the application, a device for deflecting forces comprises a force deflector for deflecting the direction of a force acting on the force deflector, wherein the force deflector comprises a protective layer. The protective layer is used to increase the robustness and/or wear resistance of the force deflector and thus of the force deflection device.

According to a preferred embodiment, the protective layer comprises a plastic. The plastic preferably comprises PVC and/or a plastic based on acrylic. The plastic preferably comprises a synthetic elastomer, especially preferably latex, more particularly natural latex or synthetic latex, a thermoplastic elastomer, a polyurethane, neoprene, a vulcanized elastomer and/or a silicone, particularly a mono-component or a multi-component silicone.

According to a preferred embodiment, the protective layer comprises a lubricant. According to another preferred embodiment, the protective layer covers a surface of the force deflector.

According to a preferred embodiment, a thickness of the protective layer is between 0.2 mm and 0.5 mm. According to a likewise preferred embodiment, a thickness of the protective layer is between 0.1 mm and 0.2 mm. According to another preferred embodiment, a thickness of the protective layer is between 0.01 mm and 0.1 mm.

According to a preferred embodiment, the force deflector comprises a protective layer matrix permeated by reinforcement fibers. The reinforcement fibers especially preferably comprise a stranded wire.

According to a preferred embodiment, the force deflector comprises a fabric or scrim made of weaving or scrim fibers, especially plastic fibers.

The fabric or scrim preferably comprises reinforcement fibers that are different from the fabric or scrim fibers. The reinforcement fibers especially preferably comprise glass fibers, carbon fibers, polyamide fibers, especially aramid fibers, metal fibers, especially steel fibers, ceramic fibers, basalt fibers, boron fibers, polyethylene fibers, high-performance polyethylene fibers, polymer fibers, crystalline fibers, liquid crystalline fibers, polyester fibers, asbestos fibers and/or natural fibers, especially hemp fibers.

According to another preferred embodiment, the force deflector comprises a belt, a cable or a chain.

According to one aspect of the application, the force deflection device is used in a device for driving a fastening element into an underlying surface, the fastener driving device comprising a mechanical energy accumulator for storing mechanical energy, an energy transmission element, movable between a starting position and a set position, for transmitting energy from the mechanical energy accumulator to the fastening element, and a force transmission device for transmitting a force from the energy accumulator to the energy transmission element.

According to another preferred embodiment, the force transmission device, in particular the force deflector, is provided for transmitting a force from the energy accumulator to the energy transmission element.

According to a preferred embodiment, the force deflector is arranged movably relative to the mechanical energy accumulator and/or relative to the energy transmission element. According to another preferred embodiment, the energy transmission element is suitable for transmitting energy from the mechanical energy accumulator to the fastening element.

According to one aspect of the application, the device comprises an energy transmission device for transmitting energy from an energy source to the mechanical energy accumulator. The energy for a driving process is preferably interim-stored in the mechanical energy accumulator in order to be abruptly output to the fastening element. The energy transmission device is preferably suitable for conveying the energy transmission element from the set position to the starting position. In particular, the energy source is preferably an electrical energy accumulator, especially preferably a battery or a rechargeable battery. The device preferably comprises the energy source.

According to one aspect of the application, the energy transmission device comprises a force transmission device for transmitting a force from the energy accumulator to the energy transmission element and/or for transmitting a force from the energy transmission device to the mechanical energy accumulator.

The mechanical energy accumulator is preferably provided to store potential energy. The mechanical energy accumulator especially preferably comprises a spring, in particular a helical spring.

According to one aspect of the application, the force transmission device comprises a force deflector for deflecting the direction of a force transmitted by the force transmission device. The force deflector is preferably arranged movably relative to the mechanical energy accumulator and/or relative to the energy transmission element.

According to one aspect of the application, the force transmission device, in particular the force deflector, more particularly the belt, is fastened to the energy transmission device.

### EMBODIMENTS

Embodiments of a device for driving fastener elements into an underlying surface and a device for deflecting forces will be described in detail below using examples, with reference to the drawings. Therein:

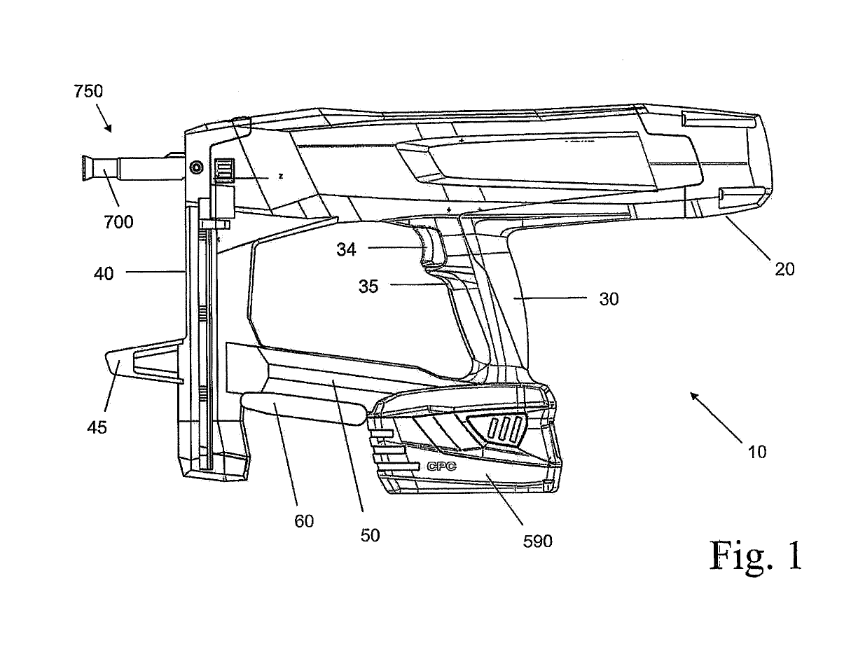

FIG. 1 shows a side view of a fastener driving device,

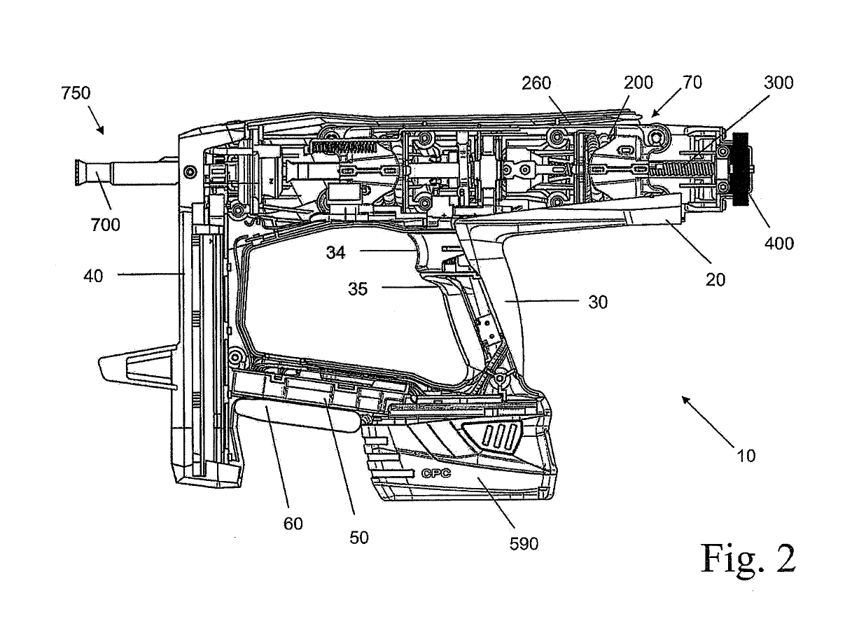

FIG. 2 shows a side view of the fastener driving device with opened housing,

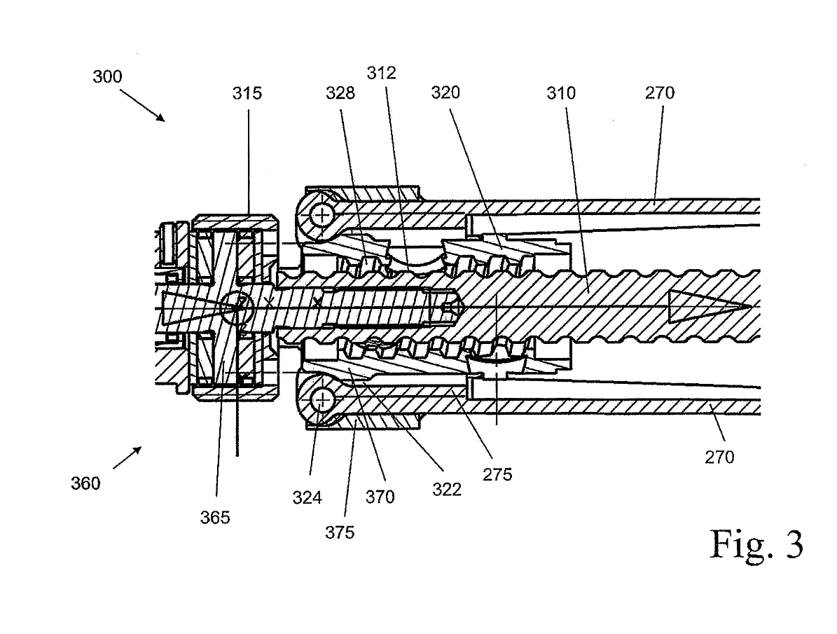

FIG. 3 shows a longitudinal section of a spindle drive,

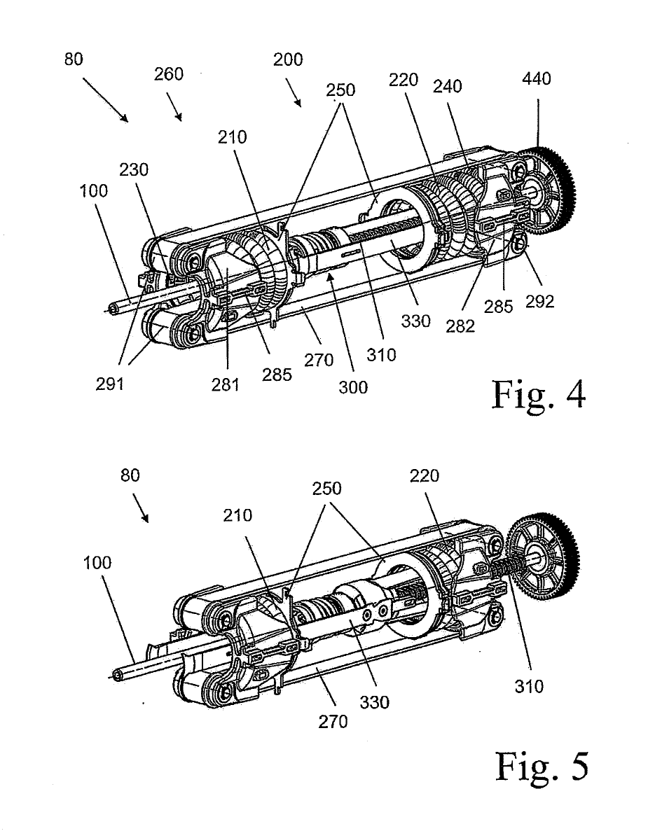

FIG. 4 shows an oblique view of a tensioning device,

FIG. 5 shows an oblique view of a tensioning device,

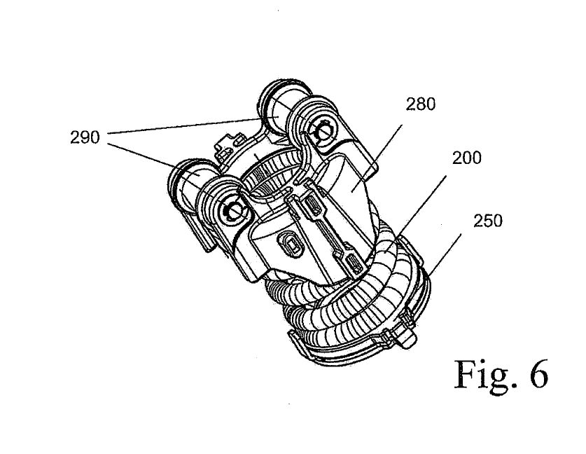

FIG. 6 shows an oblique view of a pulley mount holder,

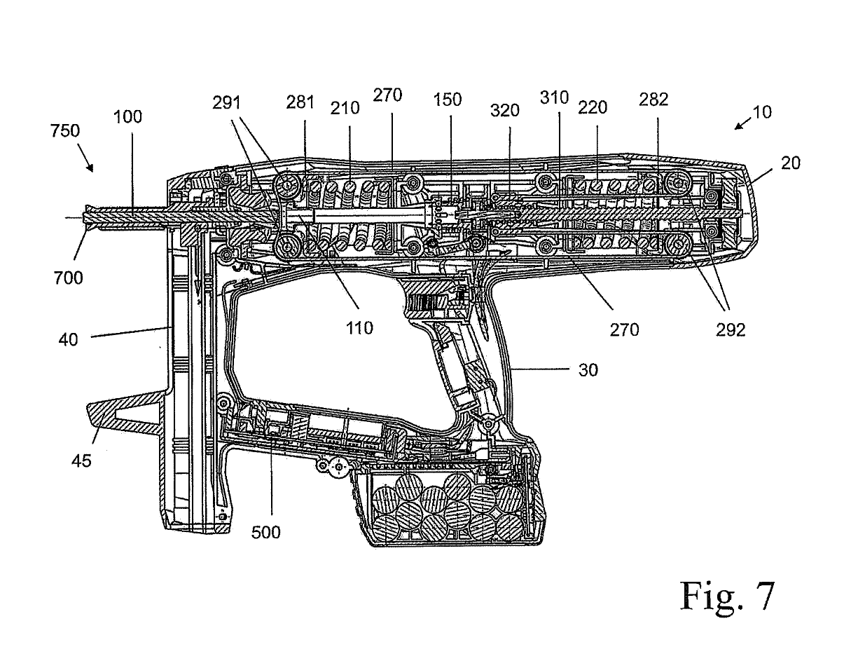

FIG. 7 shows a longitudinal section of a fastener driving device,

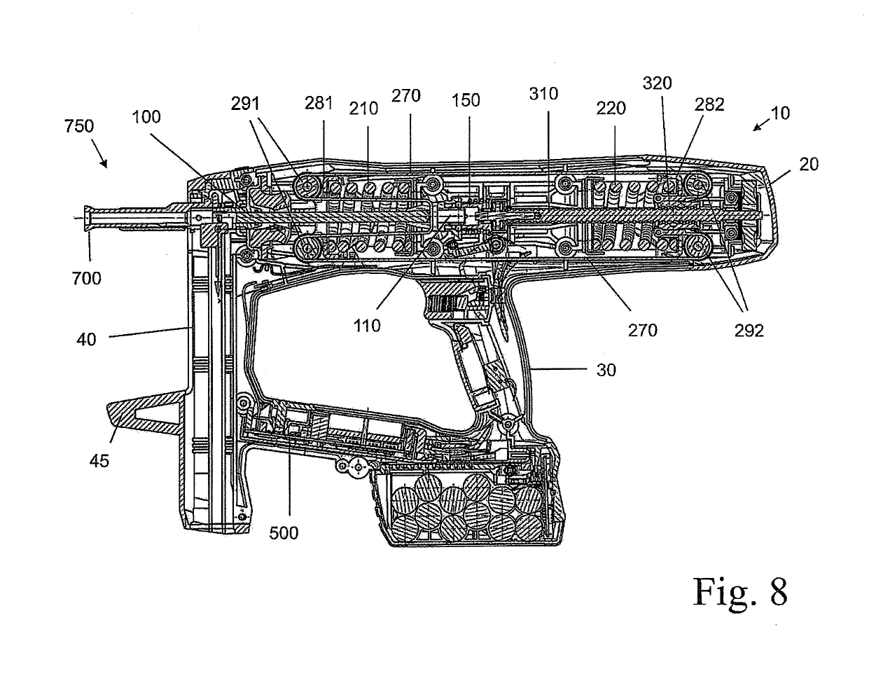

FIG. 8 shows a longitudinal section of a fastener driving device, and

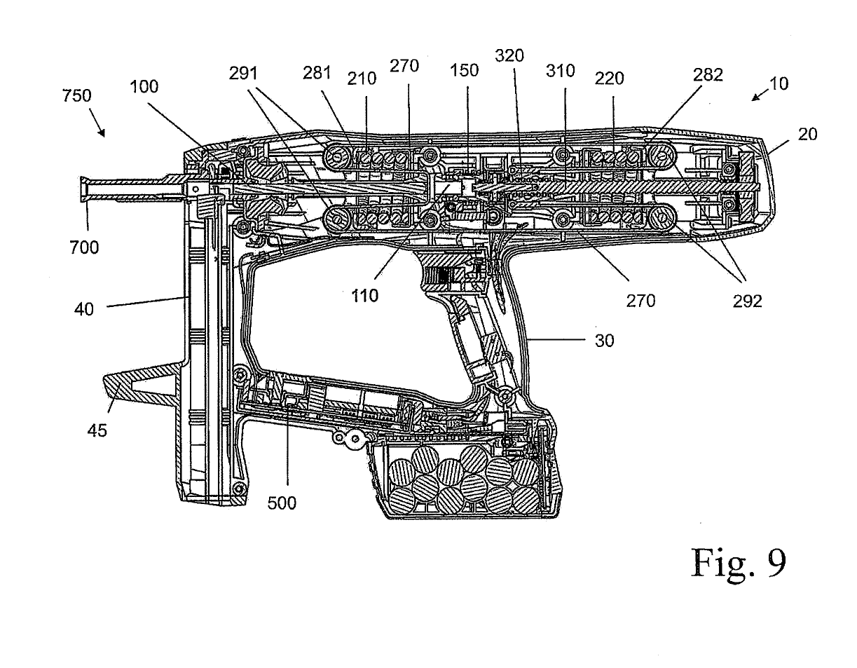

FIG. 9 shows a longitudinal section of a fastener driving device.

In a side view, FIG. 1 shows a fastener driving device 10 for driving a fastening element such as a nail or bolt into an underlying surface. The fastener driving device 10 has an energy transmission element, not shown, for transmitting energy to the fastening element, as well as a housing 20 that houses the energy transmission element and a drive unit, likewise not shown, for conveying the energy transmission element.

The fastener driving device 10 further comprises a handle 30, a magazine 40 and a bridge 50 connecting the handle 30 to the magazine 40. The magazine is not removable. An energy accumulator configured as a rechargeable battery 590 and a scaffold hook 60 for suspending the fastener driving device 10 on a scaffold or the like are mounted on the bridge 50. A trigger 34 and a handle sensor configured as a manual switch 35 are arranged on the handle 30. The fastener driving device 10 further comprises a guide channel 700 for guiding the fastening element and a contacting device 750 for recognizing a distance of the fastener driving device 10 from an underlying surface, not shown. Alignment of the fastener driving device perpendicular to an underlying surface is assisted by an alignment aid 45.

FIG. 2 shows the fastener driving device 10 with an opened housing 20. The housing 20 accommodates a drive unit 70 for conveying an energy transmission element that is concealed in the drawing. The drive unit 70 comprises an electric motor, not shown, for converting electrical energy from the rechargeable battery 590 into rotational energy, a torque transmission unit comprising a gear unit 400 for transmitting a torque of the electric motor to a movement converter constructed as a spindle drive 300, a force transmission device comprising a pulley assembly 260 for transmitting a force from the movement converter onto a mechanical energy accumulator constructed as a spring 200 and for transmitting a force from the spring onto the energy transmission element.

FIG. 3 shows a spindle drive 300 with a spindle 310 and a spindle nut 320 in a partial longitudinal section. The spindle nut has an inside thread 328 that is engaged with an outside thread 312 of the spindle.

A force deflector constructed as a belt 270 of a force transmission unit is fastened to the spindle nut 320 in order to transmit a force from the spindle nut 320 to a mechanical energy accumulator, not shown. For this purpose, the spindle nut 320 comprises an external clamping sleeve 375 in addition to an internal threaded sleeve 370, a gap between the threaded sleeve 370 and threaded sleeve 375 forming a passage 322. The belt 270 is run through the passage 322 and fastened to a locking element 324 by wrapping the belt 270 around the locking element 324 and feeding it back through the passageway 322, where one end 275 of the belt is sewn to the belt 270. Like the passage 322, the locking element is preferably shaped circumferentially as a locking ring.

The belt is preferably configured as a textile belt and comprises a plurality of individual fibers. In an embodiment that is not shown, the force deflector is configured as a cable that preferably comprises a plurality of individual fibers. In another embodiment that is not shown, the force deflector is constructed as a chain of individual chain links.

Transverse to the passage 322, i.e. in the radial direction relative to a spindle axis 311, the locking element 324, together with the formed belt loop 278, has a greater width than the passage 322. Thus the locking element 324 with the belt loop 278 cannot slip through the passage 322, so that the belt 270 is fixed to the spindle nut 320.

Because the belt 270 is fixed to the spindle nut 320, it is guaranteed that a tension force of the mechanical energy accumulator, not shown, constructed in particular as a spring, is deflected by the belt 270 and directly transmitted to the spindle nut 320. The tension force is transmitted by the spindle nut 320 via the spindle 310 and a tie rod 360 to a clutch device, not shown, that holds a piston, likewise not shown. The tie rod comprises a spindle mandrel 365 that is connected fixedly to the spindle 310 at one end and rotatably seated in a spindle bearing 315 at the other end.

FIG. 4 shows an oblique view of a force transmission device constructed as a pulley assembly 260 for transmitting a force unto a spring 200. The spring 200 has a front spring element 210 with a front spring end 230 and a rear spring element 220 with a rear spring end 240. The pulley assembly 260 has a force deflector formed by a belt 270 as well as a front pulley mount 281 with front pulleys 291 and a rear pulley mount 282 with rear pulleys 292. The pulley mounts 281, 282 are preferably made from a plastic, particularly a fiber-reinforced plastic. The pulley mounts 281, 282 have guide rails 285 for guiding the pulley mounts 281, 282 in a housing, not shown, of the fastener driving device, in particular in grooves of the housing.

The front end 230 of the front spring element 210 is held in the front pulley mount 281, while the rear end 240 of the rear spring element 220 is held in the rear pulley mount. The spring elements 210, 220 are braced at their sides facing one another on support rings 250. Because of the symmetrical arrangement of the spring elements 210, 220, the recoil forces of the spring elements 210, 220 cancel one another, so that the operating comfort of the fastener driving device is improved.

The belt 270 is engaged with the spindle nut 320 and a piston 100, and is placed over the pulleys 291, 292 so that the pulley assembly 260 is formed. The piston 100 is coupled to a clutch device, not shown. The pulley assembly effects a transmission of a relative velocity of the spring ends 230, 240 relative to one another into a speed of the piston 100 by a factor of two. If two identical springs are used, the pulley assembly thus effects a transmission of the speed of each of the spring ends 230, 240 into a speed of the piston 100 by a factor of four.

A spindle drive 300 with a spindle wheel 440, a spindle 310 and a spindle nut arranged inside the rear spring element 220 is also shown, a driving element 330 fixed to the spindle nut also being visible.

FIG. 5 shows the pulley assembly 260 in a tensioned state of the spring 200. The spindle nut 320 is now situated at the clutch end of the spindle 310 and pulls the belt 270 into the rear spring element. Thereby the pulley mounts 281, 282 are moved toward one another and the spring elements 210, 220 are tensioned. The piston 100 is held by the clutch device 150 against the spring force of the spring elements 210, 220.

FIG. 6 shows the spring 200 in an oblique view. The spring 200 is constructed as a helical spring and is manufactured from steel. One end of the spring 200 is held in the pulley mount 280 and the other end of the spring 200 is braced on a support ring 250. The pulley mount 280 has pulleys 290 that project downward from the pulley mount 280 on the side of the pulley mount 280 facing away from the spring 200. The pulleys are rotatably seated about mutually parallel axes and allow a belt, not shown, to be pulled into the interior of the spring 200.

FIG. 7 shows a longitudinal section of the fastener driving device 10, after a fastening element has been driven forward into an underlying surface, i.e. to the left in the drawing, with the aid of the piston 100. The piston is in a set position. The front spring element 210 and the rear spring element 220 are in the relaxed state, in which they actually still have a residual tension. The front pulley mount 281 is in its farthest forward position during the operating sequence and the rear pulley mount 282 is in its farthest backward position during the operating sequence. The spindle nut 320 is located at the front end of the spindle 310. Due to the fact that the spring elements 210, 220 are relaxed other than a residual tension, the belt 270 is substantially load-free.

As soon as the control unit 500 has recognized by means of a sensor that the piston 100 is in the set position, the control unit 500 initiates a return process in which the piston 100 is conveyed back into its starting position. For this purpose, the motor rotates the spindle 310 in a first rotational direction via the gear unit 400, so that the rotationally fixed spindle nut 320 is moved backward.

The return rods engage in the return pin of the piston 100 and thereby move the piston 100 to the rear as well. The piston 100 carries along the belt 270, but the spring elements 210, 220 are not tensioned thereby, because the spindle nut 320 likewise carries the belt 270 to the rear and thereby the rear pulleys 292 release exactly the same length of belt as the piston pulls in between the front pulleys 291. The belt 270 thus remains substantially load free during the return process.

FIG. 8 shows a longitudinal section of the fastener driving device 10 after the return process. The piston 100 is in its initial position and is coupled with its coupling insertion part 110 in the clutch device 150. The front spring element 210 and the rear spring element 220 continue to be in their respective relaxed state, the front pulley mount 281 is in its farthest forward position and the rear pulley mount 282 is in its farthest backward position. The spindle nut 320 is located at the rear end of the spindle 310. The belt 270 continues to be substantially load-free due to the relaxed spring elements 210, 220.

If the fastener driving device is now lifted off the underlying surface, so that the contacting device 750 is displaced forward relative to the guide channel 700, the control unit 500 initiates a tensioning process in which the spring elements 210, 220 are tensioned. For this purpose, the motor rotates the spindle 310 in a second rotational direction opposite to the first rotational direction via the gear unit 400, so that the rotationally fixed spindle nut 320 is moved forward.

The clutch device 150 holds the coupling insertion part 110 of the piston 100 fixed, so that the length of belt that is drawn in between the rear pulleys 292 by the spindle nut 320 is not released by the piston. The pulley mounts 281, 282 are therefore moved toward one another and the spring elements 210, 220 are tensioned.

FIG. 9 shows a longitudinal section of the fastener driving device 10 after the tensioning process. The piston 100 continues to be in its initial position and is coupled with its coupling insertion part 110 in the clutch device 150. The front spring element 210 and the rear spring element 220 are tensioned, the front pulley mount 281 is in its farthest backward position and the rear pulley mount 282 is in its farthest forward position. The spindle nut 320 is located at the front end of the spindle 310. The belt 270 deflects the tensioning force of the spring elements 210, 220 at the pulleys 291, 292 and transmits the tensioning force onto the piston 100, which is held against the tensioning force by the clutch device 150.

The fastener driving device is now ready for a driving process. When a user pulls the trigger 34, the clutch device 150 releases the piston 100, which then transmits the energy of the spring elements 210, 220 to a fastening element and drives the fastening element into the underlying surface.

The force deflector, constructed more particularly as a belt, has a preferably elastic protective layer. The protective layer supports and/or cushions a fabric structure of the force deflector, reduces its internal friction under deformation and avoids buckling of individual fibers under a compressive stress on the force deflector. The protective layer also prevents penetration of dust or similar particles into the belt and thus protects the force deflector from environmental influences or accelerated aging.

In some embodiments, individual fibers or fiber bundles are furnished with the protective layer. In a preferred embodiment, the entire force deflector is furnished with the protective layer.

Internal or external friction is achieved under certain conditions by an alternative or additional protective layer configured as a lubricant. The lubricant preferably comprises an oil, a grease, a solid lubricant such as graphite or MoS₂, Teflon, wax or the like.

According to one embodiment, the protective layer is applied to the force deflector or introduced into it by means of an injection molding process. It is possible to furnish the force deflector locally and in a targeted manner with the protective layer, particularly one made from plastic.

According to another embodiment, the protective layer is applied to the force deflector or introduced into the force deflector by means of a two-component cold casting process. The process temperature is preferably roughly 80° C. It is also possible to furnish the force deflector locally and in a targeted manner with the protective layer, particularly one made from polyurethane.

According to another embodiment, the protective layer is applied to the force deflector or introduced into the force deflector by means of an extrusion process. It is also possible to furnish the force deflector continuously with the protective layer, particularly one made from plastic.

According to another embodiment, the protective layer is applied to the force deflector or introduced into the force deflector mechanically, particularly as a protective jacket and/or thermally, particularly as a shrink tube. The protective layer is applied to the force deflector while avoiding air inclusions that may occur in some cases.

According to another embodiment, the protective layer is applied to the force deflector or introduced into the force deflector by means of an immersion process. It is possible to perform the process by machine or manually, continuously or discontinuously in either case.

According to additional embodiments, the protective layer is applied to the force deflector or introduced into the force deflector by vulcanization, by a spraying process, by lamination of a film or by application of an adhesive, especially an elastic adhesive.

The invention was described based on a force deflector for a device for driving a fastening element into an underlying surface. It is hereby pointed out, however, that the force defector according to the invention can also be used for other purposes.

1. A device for deflecting forces, comprising a force deflector for deflecting the direction of a force acting on the force deflector, wherein the force deflector comprises a protective layer.

2. The device according to claim 1, wherein the protective layer comprises a plastic, a plastic based on acrylic and/or a synthetic elastomer, a thermoplastic elastomer, a polyurethane, neoprene, a vulcanized elastomer and/or a silicone.

3. The device according to claim 1, wherein the protective layer comprises a lubricant.

4. The device according to claim 1, wherein the protective layer covers a surface of the force deflector.

5. The device according to claim 1, wherein the force deflector comprises a protective layer matrix permeated by reinforcement fibers.

6. The device according to claim 5, wherein the reinforcement fibers comprise a stranded wire.

7. The device according to claim 1, wherein the force deflector comprises a fabric or scrim.

8. The device according to claim 7, wherein the fabric or scrim comprise synthetic fibers.

9. The device according to claim 8, wherein the fabric or scrim comprises reinforcement fibers that differ from the fabric or scrim fibers.

10. The device according to claim 9, wherein the reinforcement fibers comprise glass fibers, carbon fibers, polyamide fibers, metal fibers, ceramic fibers, basalt fibers, boron fibers, polyethylene fibers, high-performance polyethylene fibers, polymer fibers, crystalline fibers, liquid crystalline fibers, polyester fibers, asbestos fibers and/or natural fibers.

11. The device according to claim 1, wherein the force deflector comprises a belt.

12. The device according to claim 1, wherein the force deflector comprises a cable.

13. The device according to claim 1, wherein the force deflector comprises a chain.

14. A device for driving a fastening element into an underlying surface, comprising a mechanical energy accumulator for storing mechanical energy, an energy transmission element movable between an initial position and a set position for transmitting energy from the mechanical energy accumulator to the fastening element, and a force transmission device for transmitting a force from the energy accumulator to the energy transmission element, wherein the force transmission device comprises a force deflector for deflecting the direction of the force transmitted by the force transmission device, and wherein the force deflector comprises a protective layer.

15. The device according to claim 14, wherein the force deflector is arranged movably relative to the mechanical energy accumulator and/or relative to the energy transmission element.

16. The device according to claim 2, wherein the plastic comprising PVC, latex and/or a silicone comprising a mono-component or a multi-component silicone.

17. The device according to claim 10, wherein the polyamide fibers comprise aramid fibers, the metal fibers comprise steel fibers, and/or the natural fibers comprise hemp fibers.

18. The device according to claim 16, wherein the latex comprises natural latex or synthetic latex.

19. The device according to claim 2, wherein the protective layer comprises a lubricant.

20. The device according to claim 3, wherein the protective layer covers a surface of the force deflector.
